(19) United States
(12) Patent Application Publication
(10) Pub. No.: US 2006/0164364 A1
(43) Pub. Date: Jul. 27, 2006

(54) Delay time correction circuit, video data processing circuit, and flat display device

(76) Inventors: Masaki Murase, Tokyo (JP); Yoshiharu Nakajima, Kanagawa (JP); Yoshitoshi Kida, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/564,473

(22) PCT Filed: Jul. 27, 2004
(86) PCT No.: PCT/JP04/11029

§ 371 Date: Jan. 13, 2006

(30) Foreign Application Priority Data
Jul. 8, 2003 (JP) 2003-280583
Oct. 7, 2003 (JP) 2003-347803

(51) Int. Cl. G09G 3/36

(52) U.S. Cl. 345/98

(57) ABSTRACT

The present invention is applied to, for example, a liquid crystal display device having a driving circuit integrally formed on an insulating substrate, and makes it possible to effectively avoid a variation in delay time in a logical circuit using TFTs or the like by inserting dummy data (DD) into input data (D1) and forcedly switching the logical level of the input data (D1) at a predetermined timing during a quiescent period (T2) in which the input data is held at a constant logical level.

### BACKGROUND OF THE INVENTION

1. Technical Field

The present invention relates to a delay time correction circuit, a video data processing circuit, and a flat display device, and can be applied to, for example, a liquid crystal display device having a driving circuit integrally formed on an insulating substrate. The present invention makes it possible to effectively avoid a variation in delay time in a logical circuit using TFTs or the like by inserting dummy data into input data and forcedly switching the logical level of the input data.

2. Background Art

In recent years, a liquid crystal display device of the type in which a driving circuit for a liquid crystal display panel is integrally integrated and configured on a glass substrate which is an insulating substrate constituting part of the liquid crystal display panel has been provided as a liquid crystal display device which is a flat display device applied to mobile terminals such as mobile phones and PDAs.

More specifically, this kind of liquid crystal display device has a display section formed by pixels which are arranged in a matrix form and each of which is made of a liquid crystal cell, a low-temperature polysilicon TFT (Thin Film Transistor) which is a switching device for the liquid crystal cell, and a storage capacitor, and is configured to display various images by driving the display section by means of various driving circuits arranged at the periphery of the display section.

Such a liquid crystal display device is configured so as to separate gradation data indicative of gradation of each pixel, which is sequentially inputted in raster scan order, for example, into gradation data for odd lines and even lines and drive the display section based on these gradation data for odd lines and even lines by means of horizontal driving circuits for odd lines and even lines which are respectively provided above and below the display section, so that wiring patterns in the display section are efficiently laid out and the pixels are arranged in fine pattern.

As to the processing of gradation data in each of the horizontal driving circuits, various contrivances have been proposed in relation to the arrangement of gradation data to be inputted to the liquid crystal display device in Japanese Patent Application Publication No. Hei 10-17371 and Hei 10-177368, for example.

This kind of logical circuit using low-temperature polysilicon TFTs which is applied to the liquid crystal display device has the problem that if an input value is held at an L level for a long time, delay time becomes long in response at the rise of the following logical level, so that the delay time varies according to the length of the immediately preceding logical level.

More specifically, in this kind of logical circuit, as shown in FIGS. 1 and 2, for example, if input data D1 (FIG. 2(B)) synchronized with a main clock MCK (FIG. 2(A)) is inputted to a level shifter 1 so as to output the input data D1 with an amplitude of 0 to 3 (V) converted to 0 to 6 (V), during a period T1 in which the logical level of the gradation data D1 switches at a duty ratio of 50 (%), a delay time tD is approximately constant. Contrarily, as shown by a period T2, if the logical level of the gradation data D1 is held at the L level for a long time, an immediately succeeding delay time td1 becomes longer than the delay time td in the period T1 (FIG. 2(C)).

Accordingly, as shown in FIG. 3, in the case where each bit D1 (FIGS. 3(B1) and 3(B2)) of the gradation data is level-shifted and is latched by a subclock SCK (FIG. 3(A)) if the gradation data is data supplied at a high transfer speed, output data D2A of the level shifter 1 can be correctly latched by the subclock SCK (FIGS. 3(B1) and 3(C1)) during the period T1 in which the logical level of each bit D1 of the gradation data switches at the duty ratio of 50 (%), but immediately after a vertical blanking period VBL, for example, the output data D2 of the level shifter 1 cannot be correctly latched (FIGS. 3(B2) and 3(C2)).

In the case where data cannot be correctly latched, in the liquid crystal display device, if the gradation data is separated into even lines and odd lines so as to drive the display section of high resolution as above mentioned, pixels will be driven with locally erroneous gradations immediately after vertical blanking periods. In addition, if, for example, a white area having a window-like shape is to be displayed in a black background, a pixel will be similarly driven with an erroneous gradation at the start of scan of the white area. In addition, in the liquid crystal display device, the gradation data D1 is inputted, for example, in a 6-bit parallel form corresponding to the number of gradation levels of the display section, so that a variation in delay time occurs in each bit of the gradation data. Accordingly, there occurs a case where erroneous data may be latched as to only a particular bit of the gradation data, so that an image to be displayed may become visually remarkably undesirable.

### DISCLOSURE OF THE INVENTION

The present invention has been made in view of the above-mentioned circumstances, and intends to propose a delay time correction circuit capable of effectively avoiding a variation in delay time in a logical circuit using TFTs or the like, a video data processing circuit using the delay time correction circuit, and a flat display device using the same.

To solve the problems, the present invention is applied to a delay time correction circuit for a data processing circuit for processing input data having a quiescent period during which the input data is held at a constant logical level for a constant period at a constant cycle, and in the delay time correction circuit, dummy data having a logical level opposite to the constant logical level is inserted into the input data at a predetermined timing during the quiescent period.

According to the configuration of the present invention, if the present invention is applied to a delay time correction circuit for a data processing circuit for processing input data having a quiescent period during which the input data is held at a constant logical level for a constant period at a constant cycle, and in the delay time correction circuit, dummy data having a logical level opposite to the constant logical level is inserted into the input data at a predetermined timing during the quiescent period, the delay time of a variation in the following logical level can be made short compared to the case where dummy data is not at all inserted, so that a variation in delay time can be effectively avoided in the logical circuit using TFTs or the like.

In addition, the present invention is applied to a data processing circuit for processing input data having a quiescent period during which the input data is held at a constant logical level for a constant period at a constant cycle, and in the data processing circuit, dummy data having a logical level opposite to the constant logical level is inserted into the input data at a predetermined timing during the quiescent period.

According to the configuration of the present invention, it is possible to effectively avoid a variation in delay time in the logical circuit using TFTs or the like, so that it is possible to perform data processing while effectively avoiding various influences due to the variation in delay time.

In addition, the present invention is applied to a flat display device so that gradation data is processed by inserting dummy data having a logical level opposite to a logical level during a horizontal blanking period into the gradation data at a predetermined timing during the horizontal blanking period of the gradation data.

According to the configuration of the present invention, it is possible to effectively avoid a variation in delay time in the logical circuit using TFTs or the like, so that it is possible to display a desired image while effectively avoiding various influences due to the variation in delay time.

According to the present invention, it is possible to provide a video data processing circuit and a flat display device both of which can effectively avoid a variation in delay time in a logical circuit using TFTs or the like.

### BRIEF DESCRIPTION OF THE DRAWINGS

FIG. 1 is a block diagram used in explaining a variation in delay time.

FIG. 2 is a timing chart used in explaining a variation in delay time.

FIG. 3 is a timing chart showing the relationship between a vertical blanking period and a delay time.

FIG. 4 is a block diagram used in explaining a correction principle for delay time according to the present invention.

FIG. 5 is a timing chart used in explaining the correction principle shown in FIG. 4.

FIG. 6 is a timing chart showing the relationship between a vertical blanking period and a delay time.

FIG. 7 is a timing chart used in explaining a variation in delay time in the case where delay time decreases.

FIG. 8 is a block diagram showing a liquid crystal display device according to Embodiment 1 of the present invention.

FIG. 9 is a block diagram showing a serial-to-parallel conversion circuit and a peripheral configuration in the liquid crystal display device shown in FIG. 8.

FIG. 10 is a connection diagram showing a latch circuit in the serial-to-parallel conversion circuit shown in FIG. 9.

FIG. 11 is a connection diagram showing a down converter in the serial-to-parallel conversion circuit shown in FIG. 9.

FIG. 12 is a schematic view used in explaining a variation in delay time in Embodiment 2.

FIG. 13 is a timing chart used in explaining the variation in delay time shown in FIG. 12.

### BEST MODE FOR CARRYING OUT THE INVENTION

Embodiments of the present invention will be described below in detail with reference to the accompanying drawings.

(1) Delay Time Correction Principle

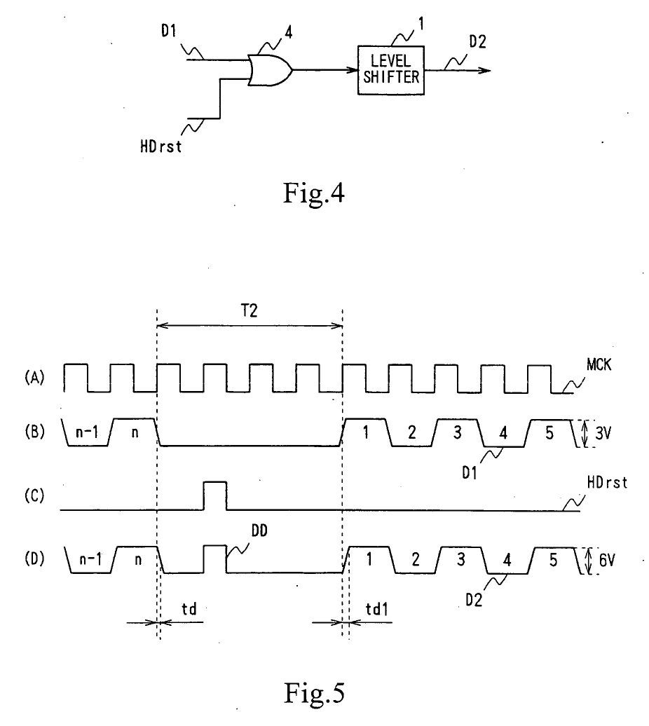

FIG. 4 is a block diagram used in explaining a delay time correction principle according to the present invention by contrast with FIG. 1. According to the correction principle, in a data processing circuit for processing input data held at a constant logical level for a constant period at a constant period, dummy data having a logical level opposite to the constant logical level is inserted into the input data at a predetermined timing during a period in which the input level is held at the constant logical level. In addition, the period in which the input data is held at the constant logical level for the constant period at the constant period is a period in which transmission of significant data is not performed, such as a horizontal blanking period in video data. The period will be hereinafter referred to as the quiescent period as needed.

More specifically, if the data processing circuit is, for example, a level shifter 1 which, as shown in FIG. 5, corrects input data D1 synchronized with a main clock MCK (FIG. 5(A)) from an amplitude of 0 to 3 (V) to an amplitude of 0 to 6 (V) and outputs output data D2 (FIGS. 5(B) and 5(D)), dummy data DD which rises from a logical L level is inserted into the gradation data D1 during a horizontal blanking period T2 in which the gradation data D1 is held at a constant logical level for a constant period at a constant cycle. Accordingly, a reset pulse HDrst based on the dummy data DD is inserted into the gradation data D1 via, for example, an OR circuit 4 (FIG. 5(C)).

Accordingly, according to the correction principle, a delay time dt1 at the rise of the logical level immediately after the horizontal blanking period T is made short compared to the case where the dummy data DD is not at all inserted, thereby solving the problem that delay time varies according to the length of the immediately preceding logical level. More specifically, if the dummy data DD is inserted in this manner, the logical level of the input data is forcedly switched and the period during which the logical level of the input data is held at a logical L level can be made short compared to the case where the dummy data DD is not at all inserted, so that a variation in delay time can be reduced in a data string of the input data D1. Accordingly, it is possible to effectively avoid latching of erroneous data and the like.

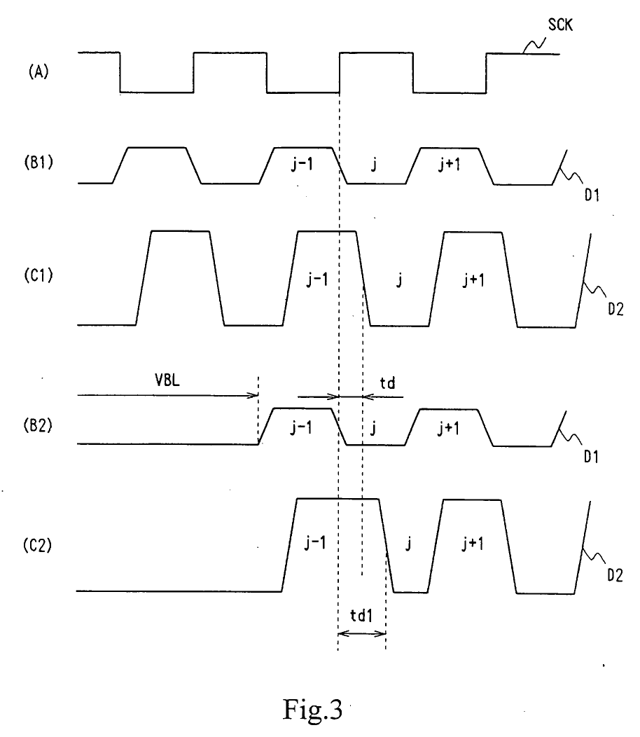

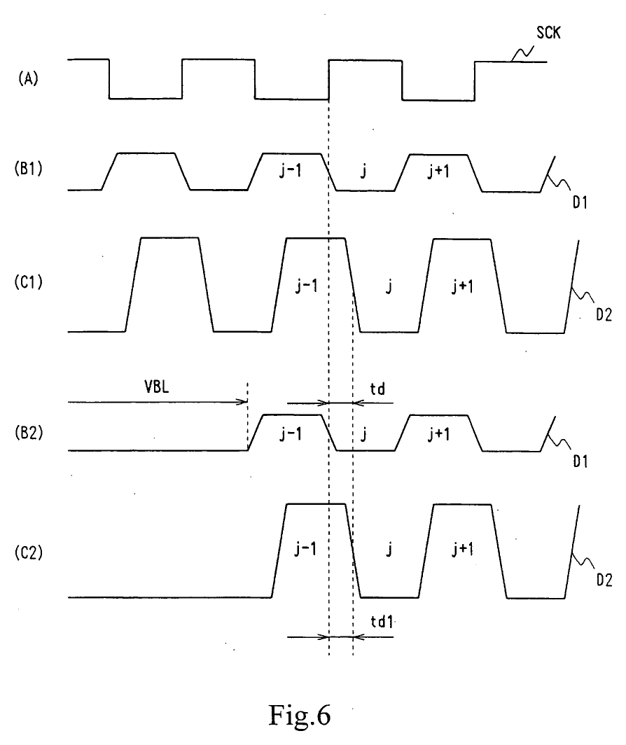

More specifically, as shown in FIG. 6 by contrast with FIG. 3, in the case where such a logical circuit output is sampled with a subclock SCK (FIG. 6(A)), the dummy data DD is inserted during horizontal blanking periods in a vertical blanking period VBL, so that the delay time of the output data D2 can be made short at the rise of the logical level following the vertical blanking period VBL and the output data D2 can be sampled and latched at a timing similar to the case of an active video period (FIGS. 6(B1) to 6(C2)). Accordingly, it is possible to display a pixel corresponding to the rise of the vertical blanking period VBL with correct gradation. In addition, in the case where black level continues over several lines and rises to white level, or in the case where a particular bit of a plurality of bits rises after being continuously held at an L level over several lines, it is possible to correctly latch the input data D1. Accordingly, a liquid crystal display device can be adapted to correctly display the gradation of each pixel.

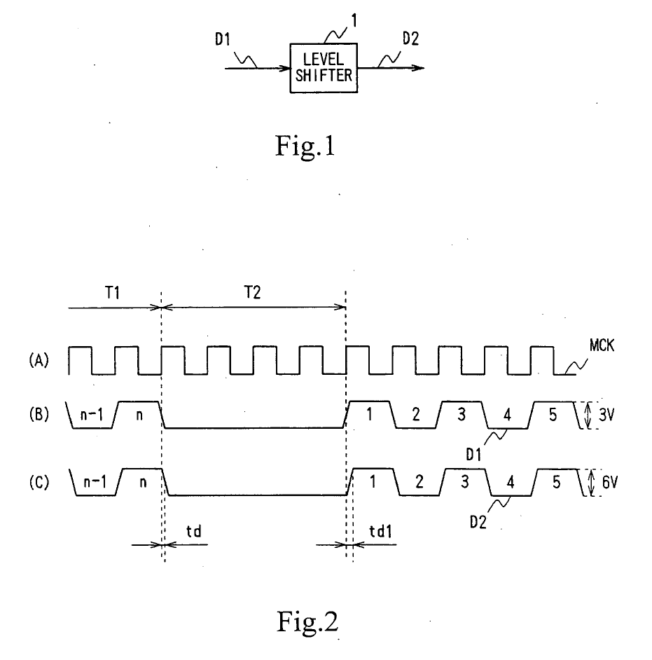

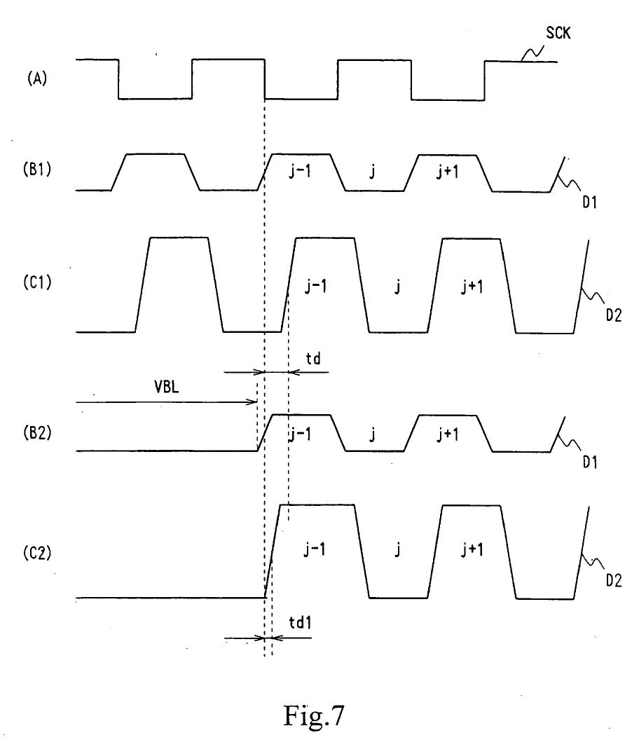

In the variation in delay time mentioned above in connection with FIG. 2, if the logical level rises immediately after the input data D1 is held at the logical L level for a long time, a delay occurs in the fall of the logical level which has risen. However, a detailed examination of the timing of the rise of the logical level has shown that if the input data D1 is held at the logical L level for a long time, delay time at the timing of the rise becomes short as shown in FIG. 7 by contrast with FIG. 3, inversely to that at the timing of the fall (FIGS. 7(A) to 7(C2)). Accordingly, if the timing of sampling of the input data D1 is set to a timing immediately before the logical level switches and if a phase margin for sampling is small, data cannot be correctly processed with a variation in delay timing associated with the timing of the rise.

However, even in a case associated with such setting, if dummy data is inserted during the quiescent period according to the correction principle, it is possible to correct a variation in delay time in a direction in which the delay time associated with the rise decreases, so that, for example, a liquid crystal display device can be adapted to correctly correct the gradation of each pixel.

(2) Configuration of Embodiment 1

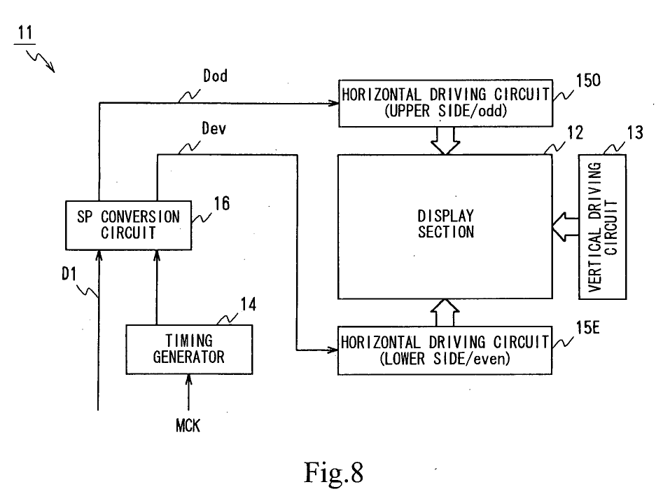

FIG. 8 is a block diagram showing a liquid crystal display device according to Embodiment 1 of the present invention. In a liquid crystal display device 11, the driving circuits shown in FIG. 8 are integrally formed on a glass substrate which is an insulating substrate of a display section 12, and driving circuits which will be described later, such as horizontal driving circuits and a timing generator, are formed by TFTs made of low-temperature polysilicon.

The display section 12 has pixels each formed by a liquid crystal cell, a TFT which is a switching device for the liquid crystal cell, and a storage capacitor, and has a rectangular shape in which these pixels are arranged in a matrix form.

A vertical driving circuit 13 drives gate lines of the display section 12 in response to various timing signals outputted from a timing generator 14, thereby sequentially selecting the pixels provided in the display section 12, in units of lines. Horizontal driving circuits 15O and 15E are provided above and below the display section 12, respectively, and after having sequentially cyclically latched gradation data Dod and Dev for odd lines and even lines, outputted from a serial-to-parallel (SP) conversion circuit 16, perform digital-to-analog conversion on the respective latch outputs and drive the corresponding ones of signal lines of the display section 12 by using the resultant driving signals. In this manner, the horizontal driving circuits 15O and 15E respectively drives odd signal lines and even signal lines of the display section 12 and set each of the pixels selected by the vertical driving circuit 13 to a gradation based on the gradation data Dod and Dev.

The timing generator 14 generates and outputs the various timing signals necessary for the operation of the liquid crystal display device 11 from various reference signals supplied from a device superior to the liquid crystal display device 11. The serial-to-parallel conversion circuit 16 separates the gradation data D1 outputted from the device superior to the liquid crystal display device 11 into the gradation data Dod and Dev for odd lines and even lines, and outputs the gradation data Dod and Dev. The gradation data D1 is data indicative of gradation for each pixel, and is formed by video data made of a continuation of red, blue and green data in raster scan order corresponding to the arrangement of the pixels of the display section 12.

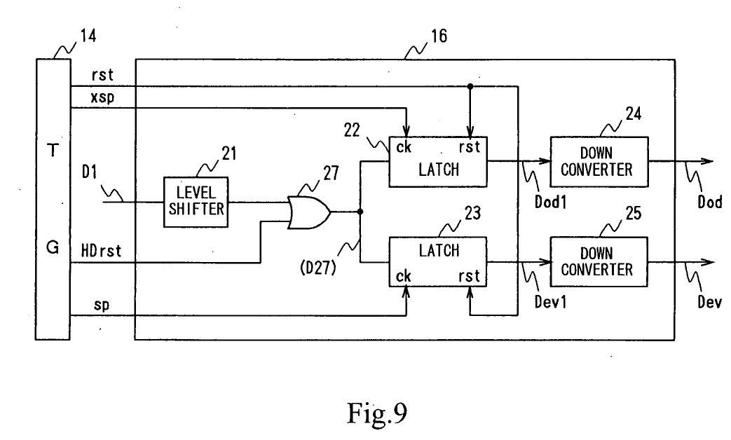

FIG. 9 is a block diagram showing the serial-to-parallel conversion circuit 16 and a configuration associated therewith. The serial-to-parallel conversion circuit 16 converts the amplitude of the gradation data D1 ranging from 0 to 3 (V) into an amplitude of 0 to 6 (V) by means of a level shifter 21, causes latch circuits 22 and 23 to alternately latch the obtained gradation data D1 to separate the gradation data D1 into the gradation data Dod and Dev for odd lines and even lines, restore the original amplitude by means of down converters 24 and 25, and outputs the resultant gradation data Dod and Dev. In this manner, the serial-to-parallel conversion circuit 16 enlarges and processes the amplitude of the gradation data D1 through level shifting by the level shifter 21 so as to reliably separate the gradation data D1 supplied at a high transfer rate into gradation data for two systems.

In the processing associated with the gradation data D1, the serial-to-parallel conversion circuit 16 has an OR circuit 27 provided at the output stage of the level shifter 21, and dummy data DD is inserted into the gradation data D1 during the horizontal blanking period of the gradation data D1 by the OR circuit 27. Accordingly, the liquid crystal display device 11 is adapted to prevent a variation in delay time due to the fact that the gradation data D1 is held at an L level for a long time, so that the gradation data D1 can be correctly latched in the following latch circuits 22 and 23. In addition, the liquid crystal display device 11 is configured to insert the dummy data DD at the output stage of the level shifter 21 in this manner, because the gradation data D1 is not erroneously latched due to only a variation in delay time occurring in the level shifter 21.

Accordingly, the timing generator (TG) 14 is configured to output and supply to the OR circuit 27 a reset pulse HDrst by which signal level is risen during each horizontal blanking period.

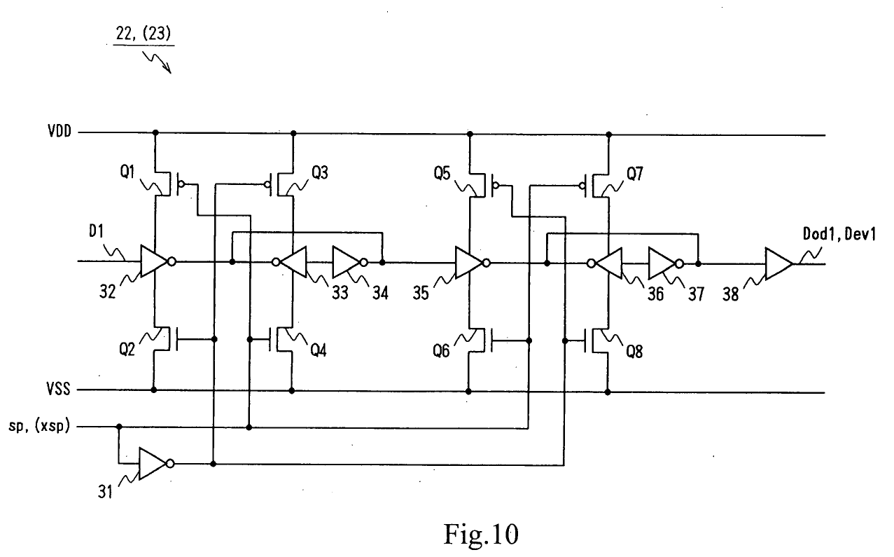

FIG. 10 is a connection diagram showing the latch circuit 22. The latch circuits 22 and 23 are identically configured except that sampling pulses sp and xsp for controlling their latch timings are respectively supplied from the timing generator 14. In what follows, reference is made to the configuration of only the latch circuit 22, but a description as to the latch circuit 23 is omitted. In addition, a reset pulse rst is shown, but the description thereof is omitted.

In the latch circuit 22, the sampling pulses p is inputted to an inverter 31, so that an inverted signal of the sampling pulse sp is generated. In the latch circuit 22, the gradation data D1 is inputted to an inverter 32 which is connected to positive and negative power sources VDD and VSS, respectively, by a P-channel MOS transistor Q1 which switches to an ON state in response to the sampling pulse sp and an N-channel MOS transistor Q2 which switches to an ON state in response to the inverted signal of the latch pulse sp outputted from the inverter 31. The output of the inverter 32 is connected to the output of an inverter 33 which is connected to the positive and negative power sources VDD and VSS, respectively, by a P-channel MOS transistor Q3 which switches to an ON state in response to the inverted signal of the sampling pulse sp and an N-channel MOS transistor Q4 which switches to an ON state in response to the sampling pulse sp, and the outputs of these inverters 33 and 32 are connected to an inverter 34 whose input is connected in common to the input of the inverter 33. In this manner, the latch circuit 22 constitutes a latch cell so as to latch the gradation data D1 in response to the sampling pulse sp.

In addition, in the latch circuit 22, the output of the inverter 34 is supplied to an inverter 35 which is connected to the positive and negative power sources VDD and VSS, respectively, by a P-channel MOS transistor Q5 which switches to an ON state in response to the inverted signal of the sampling pulse sp and an N-channel MOS transistor Q6 which switches to an ON state in response to the sampling pulses p. In addition, the output of the inverter 35 is connected to the output of an inverter 36 which is connected to the positive and negative power sources VDD and VSS, respectively, by a P-channel MOS transistor Q7 which switches to an ON state in response to the sampling pulse sp and an N-channel MOS transistor Q8 which switches to an ON state in response to the inverted signal of the sampling pulse sp, and the outputs of these inverters 35 and 36 are connected to the output of an inverter 37 whose input is connected in common to the input of the inverter 36. In the latch circuit 22, the output from the inverter 37 is outputted via a buffer 38. In this manner, the latch circuit 22 outputs gradation data Dod1 and Dev1 of amplitude 0 to 6 (V) which are respectively formed by separating the gradation data D1 into odd lines and even lines.

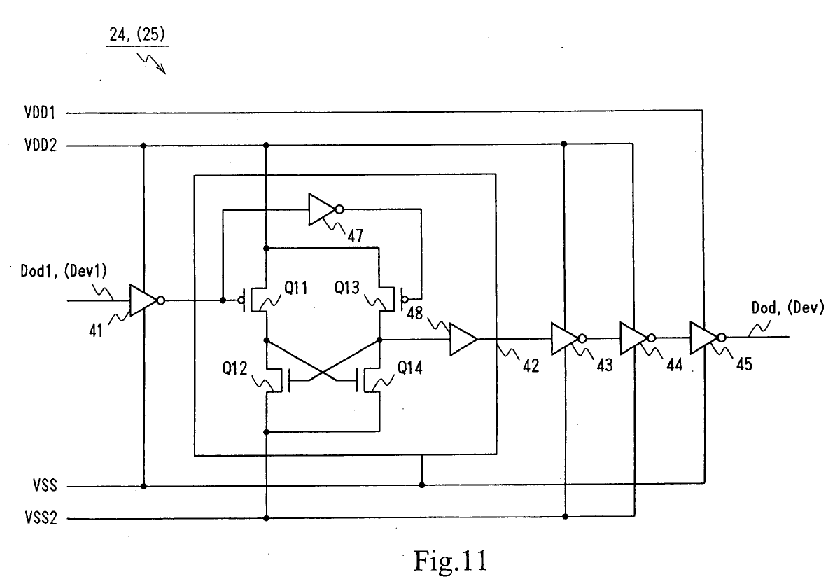

FIG. 11 is a connection diagram showing the down converter 24. The down converters 24 and 25 are identically configured except that data to be processed by them is different. In what follows, reference is made to the configuration of only the latch circuit 24, but a description as to the latch circuit 25 is omitted.

The down converter 24 is configured with an inverter 41 which operates by means of a positive power source VDD2 of 6 (V) and a negative power source VSS of 0 (V), a level shifter 42 which causes the negative level of the inverter 41 to fall to −3 (V), a series circuit of inverters 43 and 44 which operate by means of the positive power source VDD2 of 6 (V) and the negative power source VSS of 0 (V) to buffer and output the output of the level shifter 42, and an inverter 45 which operates by means of a positive power source VDD1 of 3 (V) and the negative power source VSS of 0 (V) to output an inverted signal of the output of the inverter 44. The down converter 24 outputs the gradation data Dod and Dev for odd lines and even lines in accordance with the original amplitude.

Specifically, the level shifter 42 is configured so that a series circuit of a P-channel MOS transistor Q11 and an N-channel MOS transistor Q12 and a series circuit of a P-channel MOS transistor Q13 and an N-channel MOS transistor Q14 are respectively connected to the positive power source VDD2 of 6 (V) and a negative power source VSS2 of −3 (V) and the drain outputs of the P-channel MOS transistors Q11 and Q13 are respectively connected to the gates of the N-channel MOS transistors Q14 and Q12. In addition, the output from the inverter 41 is directly inputted to the P-channel MOS transistor Q11 and is also inputted to the other P-channel MOS transistor Q13 via an inverter 47. The level shifter 42 outputs the drain output of the P-channel MOS transistor Q13 via a buffer 48, thereby outputting the gradation data Dod and Dev in a level-shifted state.

(3) Operation of Embodiment 1

According to the above-mentioned configuration, in the liquid crystal display device 11 (FIG. 8), the gradation data D1 which is inputted in raster scan order is separated into the gradation data Dod and Dev for even lines and odd lines by the serial-to-parallel conversion circuit 16, and the signal lines of the even lines and odd lines of the display section 12 are respectively driven by the horizontal driving circuits 15O and 15E in accordance with the gradation data Dod and Dev for even lines and odd lines. The gate lines of the display section 12 are driven by the vertical driving circuit 13 in response to timing signals corresponding to the gradation data D1, so that the pixels of the display section 12 whose signal lines are driven by the horizontal driving circuits 15O and 15E are sequentially selected in units of lines, whereby an image based on the gradation data D1 is displayed on the display section 12 in which wiring patterns are efficiently laid out so as to arrange pixels in fine pattern.

In the liquid crystal display device 11, during the separation of the gradation data D1 into the gradation data Dod and Dev for two systems (FIG. 9), the gradation data D1 is enlarged in amplitude by the level shifter 21 and is separated in to data for two systems, so that the gradation data D1 supplied at a high transfer rate corresponding to the resolution of the display section 12 is reliably separated in to the gradation data Dod and Dev for two systems.

During this processing, in the liquid crystal display device 11, because the latch circuits 22 and 23 alternately latch the gradation data D1 to separate the gradation data D1 into the gradation data Dod and Dev for two systems and because the driving circuits including the serial-to-parallel conversion circuit 16 are integrally formed on the glass substrate which is the insulating substrate of the display section 12 and are made of low-temperature polysilicon, if each bit of the gradation data is held at an L level for a long time, delay time increases at the fall of the subsequent logical level after the rise thereof, so that the latch circuits 22 and 23 become unable to correctly latch the gradation data D1. Contrarily, delay time decreases at the rise of the logical level, and in this case as well, the latch circuits 22 and 23 become unable to correctly latch the gradation data D1, depending on conditions.

For this reason, in this embodiment, as to the gradation data which is input data having a quiescent period during which the input data is held at a constant logical level for a constant period at a constant cycle, the dummy data DD having a logical level opposite to the constant logical level of the gradation data is inserted into the gradation data D1 at a predetermined timing during a horizontal blanking period which is such quiescent period by the OR circuit 27 provided at the output stage of the level shifter 21. (FIGS. 5 and 6).

Consequently, in the liquid crystal display device 11, as compared with the case where the dummy data DD is not at all inserted, it is possible to eliminate a variation in delay time at the rise of a logical level following a horizontal blanking period, so that it is possible to ensure a delay time similar to the period during which the logical level is inverted at a different duty ratio of 50 (%). Accordingly, this embodiment makes it possible to effectively avoid a variation in delay time in a logical circuit using TFTs or the like. In addition, in a liquid crystal display device which is a data processing circuit for video data, it is possible to effectively avoid display based on erroneous gradation due to a variation in delay time.

More specifically, in the liquid crystal display device 11, at the rise of a logical level following vertical blanking, it is possible to correct a variation in delay time associated with switching between the gradation data D1 which enter the latch circuits 22 and 23, so that the latch circuits 22 and 23 can sample the gradation data D1 at a timing similar to the case of an active video period and correctly separate the gradation data D1 into the gradation data Dod and Dev for two systems. Accordingly, it is possible to display a pixel corresponding to the rise of a vertical blanking period VBL with correct gradation. In addition, in the case where black level continues over several lines and rises to white level, and further, in the case where a particular bit of a plurality of bits rises after being continuously held at an L level over several lines, it is possible to correctly latch the input data D1, so that the liquid crystal display device can be adapted to correctly display the gradation of each pixel.

In the correction associated with delay time, it is possible to enlarge the margin of the processing of latch in each of the horizontal driving circuits 15O and 15E in the time-axis direction, so that the liquid crystal display device 11 can stably operate to reliably display a desired image.

(4) Advantage of Embodiment 1

According to the above-mentioned configuration, it is possible to effectively avoid a variation in delay time in a logical circuit using TFTs, by inserting the dummy data DD into the gradation data D1 which is input data and forcedly switching the logical level of the gradation data D1. Accordingly, the processing of video data can be adapted to correctly process video data, so that the liquid crystal display device can display a desired image with correct gradation.

In addition, in the processing of the gradation data which is video data, by inserting the dummy data DD during each horizontal blanking period, it is possible to correct a variation in delay time and correctly process the video data at the rise of a logical level immediately after a vertical blanking period, and at the rise of a logical level immediately after the logical level falls over a period of several lines.

(5) Embodiment 2

The above-mentioned embodiment 1 is configured to insert dummy data during a horizontal blanking period and prevent an increase in delay time associated with the fall of logical level following the horizontal blanking period, on the basis of the view that it is possible to prevent a variation in delay time in a logical circuit using TFTs or the like by inserting dummy data during a quiescent period.

Contrarily, as mentioned in connection with the delay time correction principle, as to the rise of logical level in the logical circuit using TFTs, oppositely to the case of the fall of logical level, with a configuration in which when the logical level of input data is held at a constant value for a constant period immediately before the rise, delay time decreases and dummy data is inserted during a quiescent period, it is possible to prevent a variation in delay time associated with such decrease in delay time.

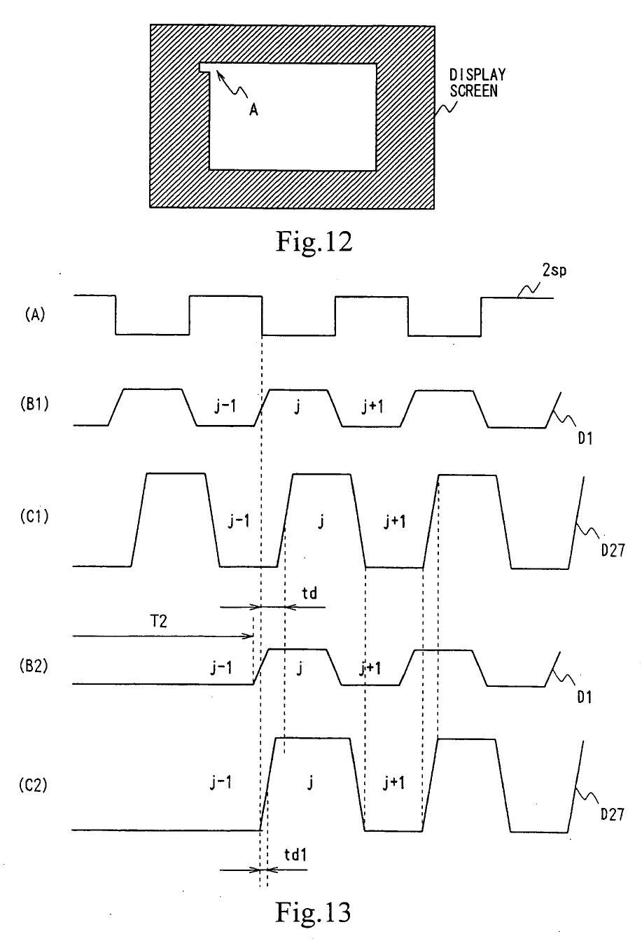

In order to verify the advantage of the configuration according to Embodiment 1 on the basis of this recognition, in the configuration shown in FIG. 9, the insertion of dummy data was stopped by stopping the supply of the reset pulse HDrst, so as to display white color in a square shape within a black frame. At this time, as indicated by an arrow A in FIG. 12, an area of white in the square shape was displayed in the state of projecting by one pixel in the horizontal direction at the start side of scanning.

In addition, when detailed observation was performed on the waveform of output data D27 of the OR circuit 27 with the sampling pulse sp triggered during that state, it was discovered that at the location which projected by one pixel in the horizontal direction, the rise timing of logical level advanced, so that a pixel to be originally latched during a logical L level was latched during the logical H level of the immediately succeeding pixel.

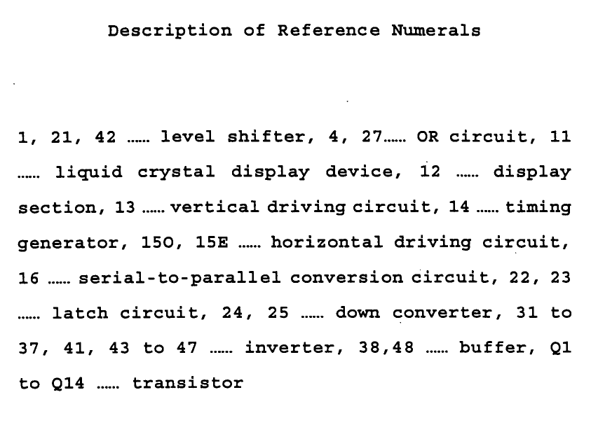

From this finding, when waveform observation was performed while switching the input data D1, it was confirmed, as shown in FIG. 13, that if the logical level of the input data was held at a constant value for a long time, only the rise timing of the logical level corresponding to the following pixel j+1 advanced, but the fall timing of the same did not at all vary (FIGS. 13(B1) to 13(C2)). In FIG. 13, symbol 2sp (FIG. 13(A)) denotes a generation reference signal for the latch pulses sp and xsp which has twice the period of each of the latch pulses sp and xsp inputted to the latch circuits 22 and 23.

Accordingly, it has been discovered that the configuration shown in FIG. 9 is a configuration which inserts dummy data during a quiescent period and prevents a variation in delay time in the logical circuit using TFTs and the variation in delay time occurs due to not an increase in delay time associated with a fall of logical level but a decrease in delay time associated with a rise of logical level.

Accordingly, according to the embodiment, it has been confirmed that even a variation in delay time due to a decrease in delay time associated with a rise of logical level can be reliably prevented as mentioned in connection with the delay time correction principle.

(6) Other Embodiments

In the above description of the embodiments, reference has been made to the case where dummy data is inserted at the output stage of a level shifter, but the present invention is not limited to this example. If even a variation in delay time in the level shifter becomes a problem when gradation data is to be processed at a far higher speed, dummy data may also be inserted at the input side of the level shifter.

In the above description of the embodiments, reference has been made to the case where dummy pulses are inserted during horizontal blanking periods, but the present invention is not limited to this example and dummy pulses may also be inserted during vertical blanking periods as needed.

In the above description of the embodiments, reference has been made to the case where the present invention is applied to a liquid crystal display device in order to correct delay time during the processing of gradation data, but the present invention is not limited to this example and can be widely applied to various processing circuits for video data.

In the above description of the embodiments, reference has been made to the case where the present invention is applied to a processing circuit for video data, but the present invention is not limited to this example and can be widely applied to cases of delay time correction in various data processing circuits.

In the above description of the embodiments, reference has been made to the case where the present invention is applied to a liquid crystal display device using active devices made of low-temperature polysilicon, but the present invention is not limited to this example and can be widely applied to various liquid crystal display devices such as liquid crystal display devices using active devices made of high-temperature polysilicon or liquid crystal display devices using active devices made of CGS (Continuous Grain Silicon), as well as various flat display devices such as EL (Electro Luminescence) display devices, and further to various logical circuits.

### INDUSTRIAL APPLICABILITY

The present invention can be applied to, for example, a liquid crystal display device having a driving circuit integrally formed on an insulating substrate.

1. A delay time correction circuit, characterized by inserting, for a data processing circuit for processing input data having a quiescent period during which the input data is held at a constant logical level for a constant period at a constant cycle, dummy data having a logical level opposite to the constant logical level into the input data at a predetermined timing during the quiescent period.

2. A data processing circuit for processing input data having a quiescent period during which the input data is held at a constant logical level for a constant period at a constant cycle, characterized by inserting dummy data having a logical level opposite to the constant logical level into the input data at a predetermined timing during the quiescent period.

3. The data processing circuit according to claim 2, characterized in that:
the input data is video data; and
the quiescent period is a horizontal blanking period or a vertical blanking period.

4. A flat display device comprising:
a display section having pixels arranged in a matrix form;
a vertical driving circuit for sequentially selecting pixels of the display section through gate lines; and
a horizontal driving circuit for converting gradation data indicative of gradations of the pixels into analog signals by sequentially sampling the gradation data, and driving the pixels selected through the gate lines by driving signal lines of the display section by the analog signals, characterized in that the gradation data is processed by inserting dummy data having a logical level opposite to a logical level during a horizontal blanking period into the gradation data at a predetermined timing during the horizontal blanking period of the gradation data.

5. The flat display device according to claim 4, characterized in that an active devices for processing the gradation data is formed by low-temperature polysilicon.

6. The flat display device according to claim 4, characterized in that an active devices for processing the gradation data is formed by CGS.
